(19) United States
(12) Patent Application Publication
(10) Pub. No.: US 2024/0378651 A1
(43) Pub. Date: Nov. 14, 2024

(54) COLLABORATIVE GIFT PURCHASING SYSTEM AND METHOD

(71) Applicant: Christen ERCEG-WILSON, New South Wales (AU)

(72) Inventor: Christen ERCEG-WILSON, New South Wales (AU)

(21) Appl. No.: 18/688,717

(22) PCT Filed: Sep. 1, 2022
(86) PCT No.: PCT/AU2022/051072

§ 371 Date: Mar. 1, 2024

(30) Foreign Application Priority Data
Sep. 2, 2021 (AU) 2021902846

(51) Int. Cl. G06Q 30/0601; G06Q 50/00

(52) U.S. Cl. CPC G06Q 30/0613; G06Q 30/0625; G06Q 30/0641; G06Q 50/01

(57) ABSTRACT

A method for collaborative gift purchasing is provided. Received are details relating to a first user including contact information relating to additional users associated with the first user. A nomination regarding a product/service that is available for purchase from supplier(s) is received from a data communications device associated with the first user, causing details relating to the product/service nominated by the first user to be published such that the details are viewable on data communication devices associated with the additional users. Receipt of requests are monitored from the data communication devices associated with the additional users to financially contribute funds to the purchase of the product/service for the first user, including when sufficient contributions have been made to fully fund the purchase of the product/service, based on detecting that sufficient contributions have been made to fully fund the purchase. The product/service is caused to be purchased from a supplier.

### FIELD OF THE INVENTION

The present invention relates to a collaborative gift purchasing system and method. In particular, the system and method provide an online platform that enables a user to nominate a particular product that the user prefers to receive as a gift and that is available for purchase from one or more online retailers, and publish details thereof to enable a plurality of the user's contacts to view and contribute funds to purchasing the particular product for the user.

### BACKGROUND OF THE INVENTION

Shopping online for products of interest has become ubiquitous in recent times and online retail is now arguably more popular than traditional retail (e.g. “bricks and mortar”) stores. Consumers shop online for a range of reasons, including for the purpose of purchasing gifts for friends and family members.

A problem with purchasing gifts for friends and family members is that the purchaser may not necessarily be aware of the type of gift the friend or family member desires. Accordingly, it is a concern for those selecting a gift that they may select a gift that is either already owned by the recipient, or represents a gift in which the recipient has limited or no interest.

For significant events such as weddings and the like, the event host(s) anticipate receiving gifts from their guests and will often advise guests in advance that they prefer to receive gifts from a particular gift catalogue (often referred to as a “gift registry”). Whilst the use of a gift registry may prevent the purchasing of duplicate gifts or gifts which are already owned by the recipient or in respect of which the recipient has limited or no interest, such registries are typically limited to one particular retailer (e.g. one department store or one supplier) and hence the extent to which the gift recipient(s) have control over the gift(s) chosen for them remains limited. For example, the recipient may desire a particular item and/or brand of kitchenware which is not listed on any available gift registry.

There may also be instances in which a person who is hosting a major event (e.g. a wedding, baby shower, or a milestone such as a birthday, engagement or anniversary) may desire a large, or expensive, gift which is unlikely to be within an affordable price range for any individual guest. For example, the host may desire an overseas holiday, or a particular item of jewellery, yet the cost of such items may be too great for a single guest to accommodate. Whilst a host could request that two or more guests contribute to the cost of such a gift, this is likely to be difficult to coordinate and may result in adverse outcomes including, for example, offending guests on the basis that they have been requested to contribute to a costly item, and/or refusal by some guests to contribute on the basis that they cannot afford the required contribution amount or prefer to purchase a gift of their own choosing. In addition, guests may subsequently argue over who will be responsible for initiating the purchase, selecting the retailer from whom to purchase the gift, and/or whether a less expensive price could have been achievable.

In addition to causing potential relationship problems between a host and their guests, and also between guests, the above scenarios are also likely to give rise to the unnecessary usage of computer and memory resources since web browsers, mobile phones and other network connected devices will be used to coordinate, amongst multiple different parties, the collaborative purchases of gifts. For example, using existing functionality of a mobile device to enable a host to contact guests to determine which guests may be interested in contributing to the gift purchase, then in respect of communications amongst the guests to coordinate the purchase of the gift, and subsequently searching for, and purchasing, the gift has the effect of consuming substantial data communications bandwidth and hence causes significant computer and network resource usage. Inefficient use of the available bandwidth of data communications networks is clearly undesirable since slow and/or unreliable data communications are frustrating (and expensive) for users. This problem is exacerbated during times of high network traffic which consume available bandwidth.

The computer-implemented system and method of the present invention seeks to accommodate the above identified problems or at least provide an alternative solution to same.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for collaborative gift purchasing, the method including, receiving, by one or more processors, details relating to a first user including contact information relating to a plurality of additional users associated with the first user, receiving, by one or more processors, from a data communications device associated with the first user, a nomination regarding a product or service that is available for purchase from one or more suppliers, causing, by one or more processors, details relating to the product or service nominated by the first user to be published such that the details are viewable on data communication devices associated with the plurality of additional users, monitoring, by one or more processors, receipt of requests from the data communication devices associated with the plurality of additional users to financially contribute funds to the purchase of said product or service for the first user, including when sufficient contributions have been made to fully fund the purchase of the product or service, based on detecting that sufficient contributions have been made to fully fund the purchase of the product or service, causing, by one or more processors, the product or service to be purchased from a supplier of the one or more suppliers.

In an embodiment, the supplier is a retail provider, manufacturer or distributor of the nominated product or service.

In an embodiment, communications with the first and each additional user, including the submittal of requests or information by each user, is facilitated by a dedicated software application operable on each user's data communication device.

In an embodiment, the software application may present the first user with a search facility to search for and select one or more products or services. In this embodiment, the search may be configured to allow the first user to filter search results according to categories such as product, service, brand, supplier, product characteristic (e.g. size, colour, year of release), and event type.

In an embodiment, the search results are based on products or services of which details have previously been uploaded to a database by suppliers of the products or services. Alternatively, the search results are based on a real-time search for products or services using an existing online platform such as Google Shopping™.

In an embodiment, the one or more additional users associated with the first user are social media contacts of the first user.

In an embodiment, the identification of additional users associated with the first user may be achieved automatically, e.g. by searching social medial platforms associated with the first user to identify those users who are linked or otherwise related to the first user.

In another embodiment, the first user is prompted to manually enter details relating to the additional users.

In an embodiment, causing details relating to the product or service nominated by the first user to be published includes creating one or more social media campaigns viewable by the additional users thereby enabling the additional users to contribute funds to the purchase of the product. Each social media campaign associated with the first user may be monitored and managed using the dedicated software application, and in this regard, the software application is configured to integrate with social medial platforms to which the first user is subscribed.

In an embodiment, the first user is enabled to select a supplier of the nominated product or service, and the first user may be prompted to specify whether the initially selected supplier is to remain selected throughout the entire campaign irrespective of the potential availability of a more favourable supplier.

In an embodiment, the additional users may view the one or more suppliers from which the nominated product or service may be purchased.

In an embodiment, the method further includes, identifying, by one or more processors, the one or more suppliers from whom the nominated product or service may be purchased by automatically performing an online search of suppliers and/or searching a dedicated database of suppliers in respect of the nominated product or service.

In an embodiment, when there is more than one supplier available for selection, the method further includes, automatically selecting, by one or more processors, a particular supplier based upon one or more attributes of the particular supplier, including one or more of, a category (e.g. type) of the nominated product or service, a price of the nominated product or service, a location of the particular supplier relative to the first user, whether the particular supplier is able to deliver the product or service directly to the first user, an estimated arrival time of the nominated product or service; and a quality rating associated with the particular supplier.

In an embodiment, after selection of a particular supplier has been made according to one or more attributes of the particular supplier, the method further includes, conducting real-time monitoring, by one or more processors, of attributes of all available suppliers to identify whether another supplier should be selected in place of the previously selected supplier based upon one or more attributes associated with the other supplier, and if the other supplier is identified as having more favourable attributes, selecting the other supplier in place of the previously selected supplier.

For example, if a first supplier is selected based upon the price of the nominated product sold by the first supplier, and it is later determined (during the course of a campaign) that a second supplier offers the same nominated product or service at a reduced price, the second supplier may be automatically selected in place of the first supplier. This selection may be based upon one or a combination of supplier attributes and is therefore not necessarily limited to which supplier is offering the product or service at the lowest price.

In an embodiment, the additional users may be provided with an opportunity to influence the selection of a particular supplier when there is more than one supplier available. For example, each additional user that contributes funds towards the purchase of the product or service may be prompted to vote for one of the available suppliers based upon, for example, a past experience with a particular supplier, and such votes may further influence supplier selection.

In an embodiment, the additional users may view which supplier is selected at any one time on an application interface or their social media feed.

In an embodiment, the additional users may nominate, at the time of submitting a request to contribute funds, an amount of funds to be contributed, and each additional user that elects to contribute funds may be prompted regarding whether their particular contribution will be published or retained confidential.

In an embodiment, the maximum amount of funds that may be selected by an additional user during the course of the campaign will be based upon one or more of, a maximum donation limit specified by the first user, and/or the remaining funds required to purchase the product or service according to the price of the product or service associated with the currently selected supplier.

In an embodiment, each request received from a data communications device associated with the plurality of additional users includes authorisation from the additional user for payment toward the purchase of the product or service. In this embodiment, the request authorises the indirect or direct transfer of funds from a bank account associated with the additional user into an account associated with the supplier, or alternatively, into an account associated with an independent trusted entity. In this embodiment, the software application may be configured to enable each additional user to schedule instalment payments rather than requiring a single payment.

In an embodiment, each of the first user and additional users may receive an alert on their respective data communications device when, new contributions are made toward the purchase of the nominated product or service, sufficient contributions have been made to fully fund the purchase of the product or service, a new supplier of the nominated product or service has been selected, the product or service has been delivered to the first user; and/or the product or service has been received by the first user.

In an embodiment, the first user may nominate more than one product of interest. In this embodiment, the first user may allocate a priority regarding the products or services nominated such that the product(s) or service(s) allocated a higher priority represents the product(s) which the first user prefers to be gifted as a priority over the remaining nominated product(s) or service(s). Accordingly, it will be appreciated that the first user may effectively develop a gift registry without the involvement of third parties and which includes products selected and prioritised according to the user's own personal preferences.

In an embodiment, the product or service may be immediately available or scheduled to be available at a future time.

In an embodiment, data relating to products or services nominated by first users as gift items may be monitored for reporting purposes.

In a second aspect, the present invention provides a system including, one or more processors operable to, receive details relating to a first user including contact information relating to a plurality of additional users associated with the first user, receive, from a data communications device associated with the first user, a nomination in relation to a product or service that is available for purchase from one or more suppliers, cause details relating to the product or service nominated by the first user to be published such that the details are viewable on data communications devices associated with the plurality of additional users, monitor receipt of requests from the data communications devices associated with the plurality of additional users to financially contribute funds to the purchase of said product or service for the first user, including when sufficient contributions have been made to fully fund the purchase of the product or service, based on detecting that sufficient contributions have been made to fully fund the purchase of the product or service, cause the product or service to be purchased from a supplier of the one or more suppliers.

In a third aspect, the present invention provides a computer-readable medium having a plurality of instructions executable by one or more processors to, receive details relating to a first user including contact information relating to a plurality of additional users affiliated with the first user, receive, from a data communications device associated with the first user, a nomination in relation to a product or service that is available for purchase from one or more suppliers, cause details relating to the product or service nominated by the first user to be published such that the details are viewable on data communications devices associated with the plurality of additional users, monitor receipt of requests from the data communication devices associated with the plurality of additional users to financially contribute funds to the purchase of said product or service on behalf of the first user, including when sufficient contributions have been made to fully fund the purchase of the product or service, based on detecting that sufficient contributions have been made to fully fund the purchase of the product or service, cause the product to be purchased from a supplier of the one or more suppliers.

### BRIEF DESCRIPTION OF THE DRAWINGS

Features of the present disclosure are illustrated by way of example and not limited in the following Figure(s), in which like numerals indicate like elements, in which:

FIG. 1 provides an overview of a system according to an embodiment of the invention, depicting, in particular, the interaction of the various system components;

FIG. 2 illustrates an exemplary diagram associated with the server component of the system illustrated in FIG. 1;

FIG. 3 illustrates an exemplary flow diagram of a process that enables a user to download and install a software application, and subsequently log in, or register, to use the software application for interacting with the system illustrated in FIG. 1;

FIG. 4 illustrates an exemplary flow diagram of a process that enables a user to create one or more requests for a product or service of interest to be gifted to the user;

FIG. 5 illustrates an exemplary flow diagram of a process that enables additional users to view the request for a product or service to be gifted and to financially contribute funds to the purchase of the product or service;

FIG. 6 illustrates an exemplary flow diagram of a process that enables the monitoring of funds received from the additional users as well as the purchase and delivery of the product or service;

FIG. 7 illustrates an exemplary flow diagram depicting interactions between a product retailer, a financial institution associated with the product retailer, and the subsequent delivery of a gift item based upon full payment being contributed by the additional users; and

FIG. 8 illustrates an exemplary flow diagram of a process that enables the integration of the system with one or more social media platforms.

### DETAILED DESCRIPTION OF EMBODIMENT(S) OF THE INVENTION

The present disclosure is described by referring to embodiment(s) thereof. In the following description, numerous specific details are set forth in order to provide a thorough understanding of the present disclosure. However, it will be readily apparent that the present disclosure may be implemented without limitation to these specific details. In other instances, other methods and structures have not been described in detail to avoid obscuring the present disclosure.

The present invention relates to at least a computer-implemented system and method for collaborative gift purchasing. In particular, the system and method provide a platform that hosts a computer-executable software application (40), wherein the application (40) is accessible by users (30) (i.e. gift recipients (30A) and gift contributors (30B)) who are registered to use the application (40). For example, the systems utilise a central server (20) in communication with data communication devices (50) associated with each user (30).

The central server (20) maintains one or more processors and/or databases for performing functions, including receiving details relating to the gift recipient (30A). Such details include contact information relating to a plurality of contacts (30B) associated with the gift recipient (30A), as well as a nomination regarding a product or service gift item (60) (e.g. bike (60A) or mobile phone (60B)), that is available for purchase from one or more suppliers (70). Based upon receipt of the details relating to the gift recipient (30A), the central server (20) causes details relating to the gift item (60) nominated by the user (30A) to be published such that the details are viewable on data communication devices (50) associated with the plurality of additional users, i.e. potential gift contributors (30B).

The server (20) may then monitor the receipt of requests from gift contributors (30B) to financially contribute funds to the purchase of the gift recipient (30A), including when sufficient contributions have been made to fully fund the purchase of the gift item (60) and hence when the gift item (60) may be purchased. Based upon detecting that sufficient contributions have been made to fully fund the purchase of the gift item (60), the server (20) may generate and transmit relevant instructions to cause the gift item (60) to be purchased from a supplier (70). For example, the server (20) may communicate directly with an ordering system associated with the supplier (70), or alternatively, may automatically generate an email or similar notification for an administrator of the system to send to the supplier to confirm the order of the gift item (60).

The skilled addressee will appreciate that by allowing gift recipients (30A) to nominate products or services of interest available for purchase from a supplier, and publishing same, users (30A) may effectively identify gifts that they would prefer to receive for upcoming events or celebrations. This facilitates the purchasing of gifts by gift contributors (30B) since the burden of locating a suitable gift of interest is removed from the gift purchasing process. As described in greater detail below, the solution further provides the opportunity for gift contributors (30B) to partially contribute to expensive items (i.e. gifts which may have a significant purchase price).

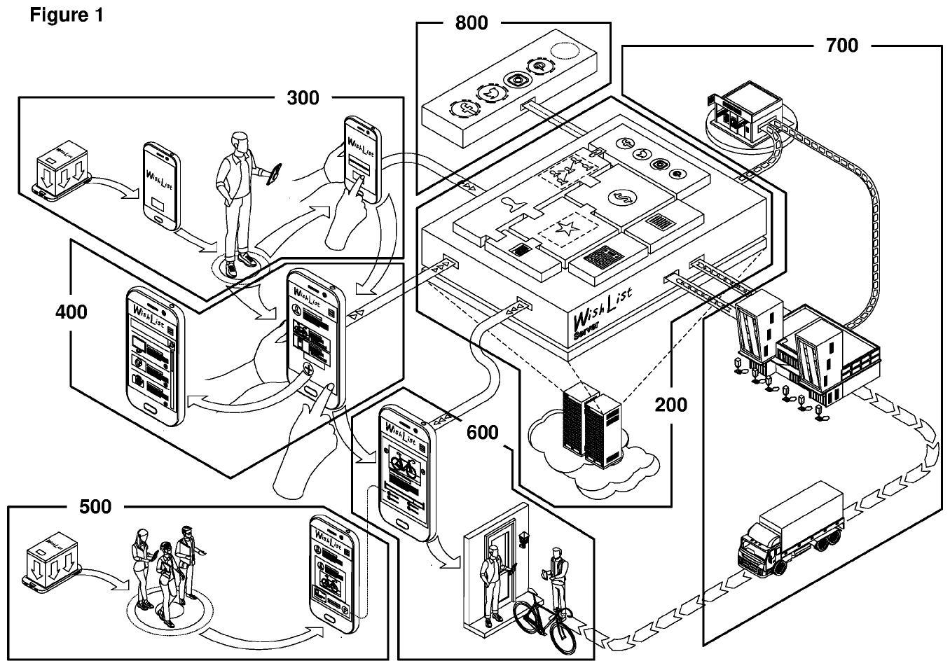

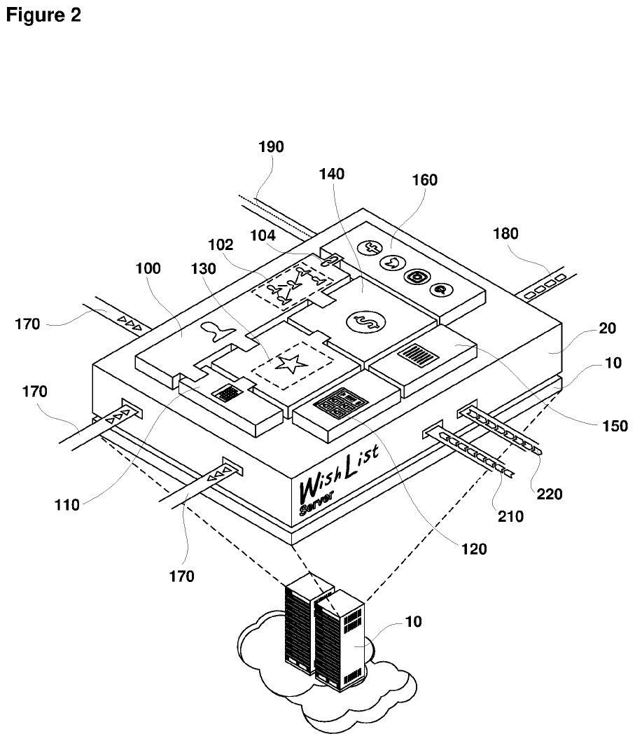

FIG. 1 is divided into segments which are further expanded in FIGS. 2 to 8. In particular, segment 200 of FIG. 1 depicts the server component (20) with which the software application (40) operating on data communication devices (50) are configured to communicate. It will be apparent to skilled readers that the software application (40) may be a mobile application or a web application and that, similarly, the data communication devices (50) utilised by users (30) may be mobile devices or computer devices. The server component (20) is additionally detailed in FIG. 2, and skilled readers will appreciate that the steps described herein, as executed by the devices (50), may be facilitated by the software application (40) operating on each device (50).

As an alternative, or in addition to steps described herein as performed by the server (20), the steps described may be performed by one or more processors associated with each user device (50). Different arrangements are possible in this regard, but according to a particular implementation of the present invention, the server (20) is programmed to provide all of the functions described herein, particularly where such functions cannot conveniently be provided locally on the user devices (50).

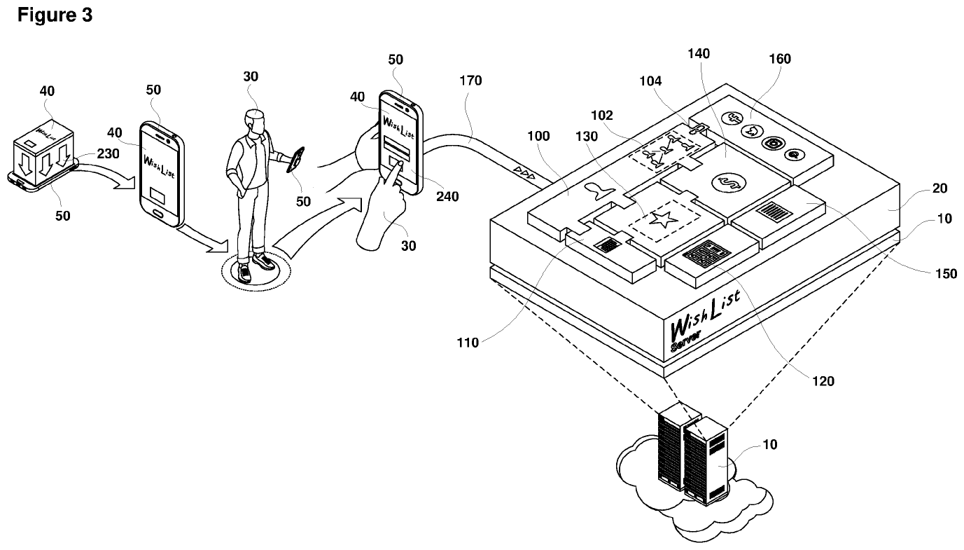

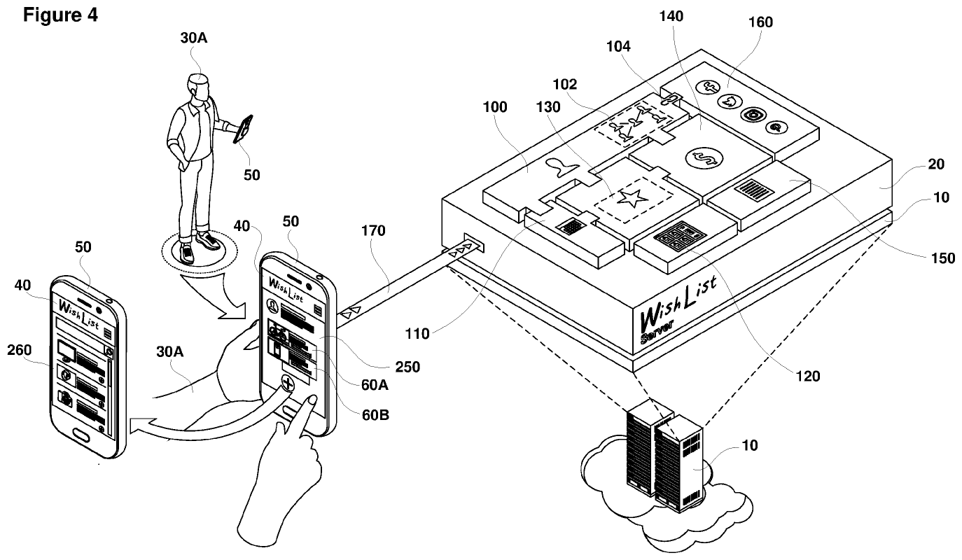

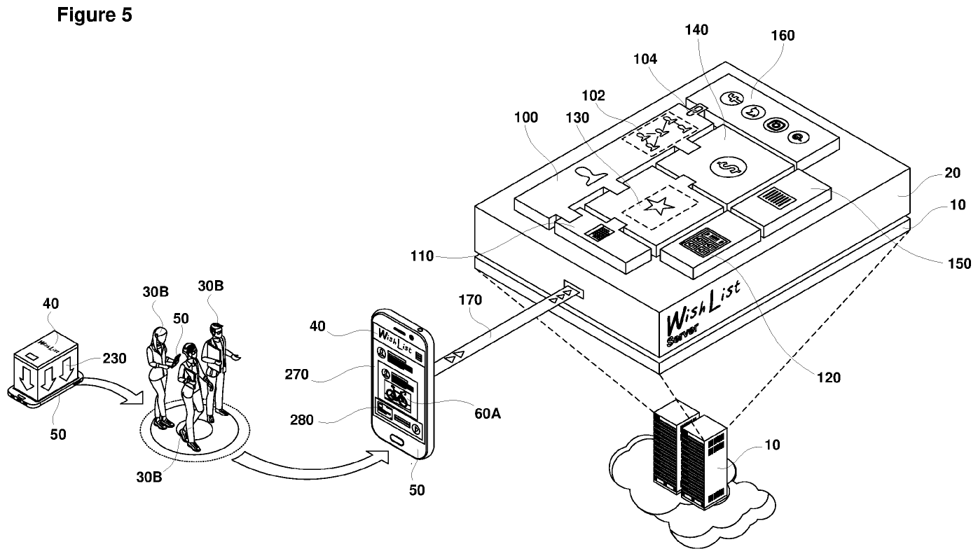

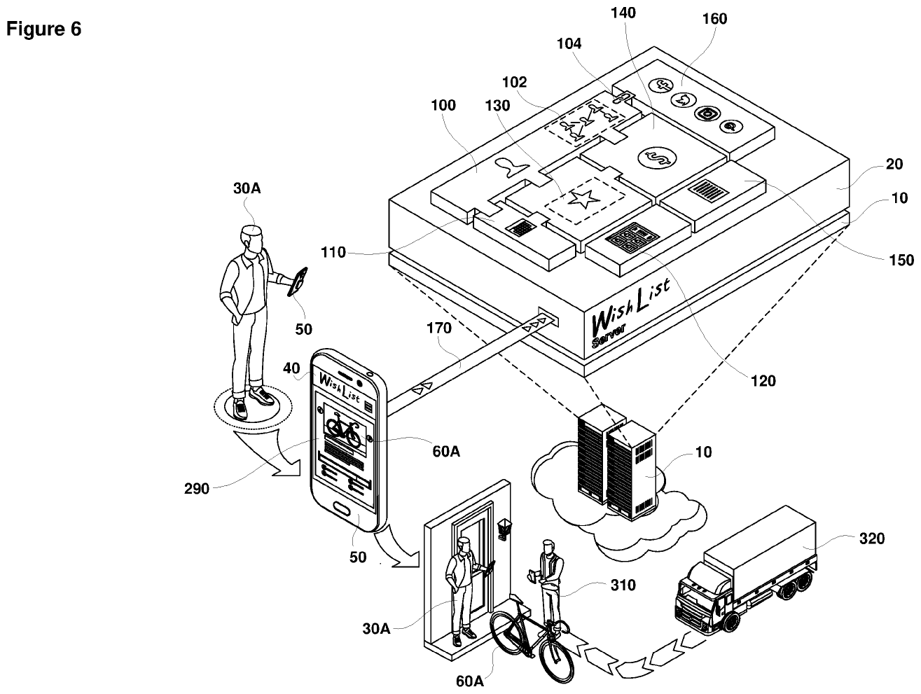

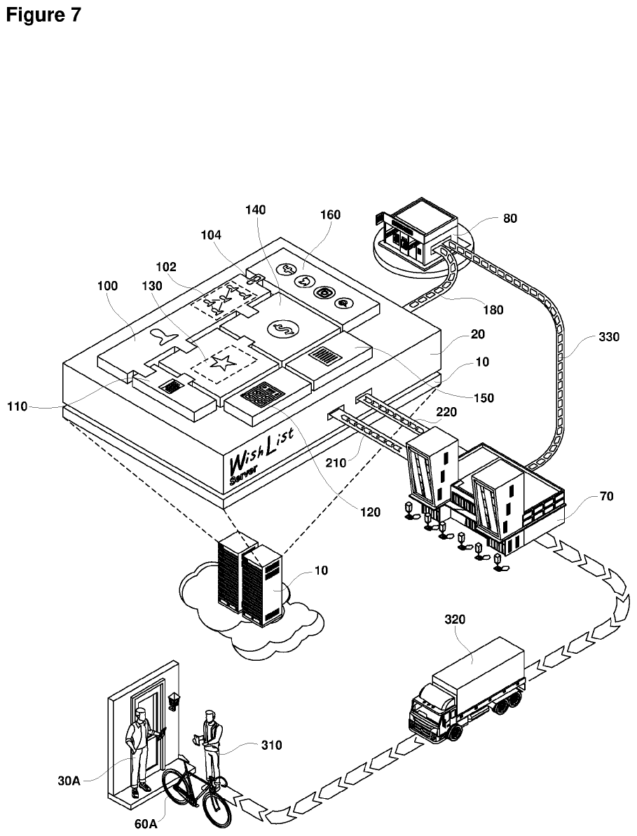

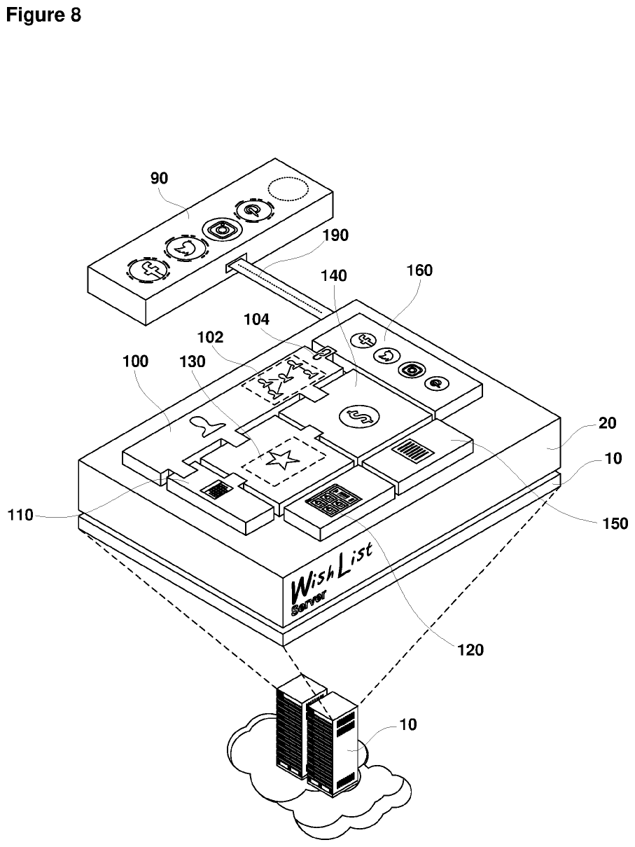

Segment 300 of FIG. 1 shows the user (30) downloading and installing the application (40) and subsequently logging into the application (40) in order to establish an account, as further detailed in FIG. 3. Segment 400 of FIG. 1 illustrates how the user (30A) may create a request for a product or service that is available for purchase, as detailed in FIG. 4. Segment 500 of FIG. 1 illustrates how details relating to the user request may be viewed by additional users (30B) who may subsequently request to financially contribute funds to the purchase of the product or service, as detailed in FIG. 5. Segment 600 of FIG. 1 illustrates how the user (30A) may monitor progress with respect to contributions made toward the purchase of the product or service as well as the delivery of same upon receipt of full payment, as further detailed in FIG. 6. Segment 700 of FIG. 1 illustrates how suppliers (70) of products or services may list their products and/or services in a catalogue (120) which users (30A) may search for the purpose of selecting a gift item (60), as further detailed in FIG. 7. Finally, Segment 800 of FIG. 1 illustrates an example integration between the application (40) and one or more external social media platforms (90), as detailed in FIG. 8.

As mentioned above, FIG. 2 shows in greater detail the segment 200 of FIG. 1, and in particular, FIG. 2 shows the server component (20) which includes infrastructure (10) on which the platform of the present invention operates. The infrastructure (10) may be local or cloud-based. The central server (20) may operate one or more computer processors and maintain one or more databases to enable the following functionality and/or storage;
User account register (100) storing details relating to users (30) that use the software application (40) including storage of user profiles containing details relating to each user and which may be relevant for the purpose of identifying the user, e.g. name, age, address, contact details, etc.;
User contact register (102) storing details relating to individuals (30B) associated with users (30A) stored in register (100) including, for example, family and friends of the users (30A) as well as social media contacts associated with each user;
Social media link register (104) storing links between each user account and any social media accounts associated with the particular user (30A);
Events database (110) storing details relating to upcoming events and celebrations associated with users (30A) such as birthdays, engagements, weddings and anniversaries;
Products and service catalogues (120) listing products and services that are available for selection using the platform including, for example, products or services that have been uploaded by one or more suppliers (70) for selection by users (30);
Gift item database (130) storing information relating to gift items (60), which may include products and/or services, that users (30A) have selected from product catalogue (120) in relation to an event (110). In other words, database (130) relates to active requests by users (30A) for gift items (60), i.e. requests for which financial contributions currently being received;
Payment functionality (140) enabling users (30B) to financially contribute towards the gift item (60), e.g. by transferring funds directly to a financial institution (80) associated with the supplier (70) or another account managed by the system administrator;
Order functionality (150) which enables the platform to initiate orders for gift items (60) that have been paid in full by gift contributors (30B), i.e. initiating orders with suppliers such as gift retailers (70);
Social media integration functionality (160) which enables integration with a range of social media platforms (90), e.g. where the user has consented to providing access to data, contact information, etc., available through one or more of the user's social media accounts.

Also shown in FIG. 2 is the ability of the server (20) to communicate (170) with the software application (40) associated with user devices (50), to communicate (180) with one or more financial institutions (80), and to communicate (190) with one or more social media platforms (90), as described above. FIG. 2 also depicts that server (20) is configured to enable communications (210, 220) with a gift item supplier (70), including communications (210) for the listing of gift items (60) onto a product catalogue (120), and for communications (220) relating to the ordering (150) of gift items (60). The abovementioned communications may occur via an application programming interface (API), network interface, or similar.

FIG. 3 shows in greater detail segment 300 of FIG. 1 and, in particular, the steps associated with a user (30) installing the user application (40), which may be achieved by downloading the application (40) from an application store. The user (30) may create an account using the application (40) and the account information may be stored in the account register (100). As described above, the user account register may capture information sufficient to enable the user (30) to be correctly identified. It will be appreciated that both gift recipients (30A) and gift contributors (30B) will require access to the application (40), hence the account registration process described above applies equally to users (30A) and (30B).

The process of installing the application (40) is indicated by arrows (230), and interface (240) is also shown which allows each user (30) to download and install the application (40) in order to access the functionality thereof, including to create and maintain a user profile. The user profile may include personal details such as the user's name and contact details, etc. and upon uploading sufficient information, each user (30) will be successfully registered such that the user becomes a registered user.

As mentioned above, users (30A) registered to select gift items (60) to be purchased on their behalf may utilise the platform to request such gift items, which items may be products and/or services. In this regard, FIG. 4 shows an example process of how such a request may be initiated. Once the user (30A) logs into the application (40), the user (30A) may be presented with an interface (250) that enables the user (30A) to browse products and/or services from a selected gift item catalogue (120), and the interface (250) may provide search functionality that enables the user (30A) to filter search results according to different attributes such as product, service, brand, supplier, product characteristic (e.g. size, colour, year of release), and event type (e.g. birthdays, weddings and anniversaries etc). Once a particular gift item (60) has been located, the user (30A) may select the gift item (60) and be presented with a further interface (260) which allows the user (30A) to view additional details associated with the particular product or service. Where there is more than one product or service selected, a list of all selected gift items may be generated and displayed, i.e. the user's “wish list”. In this way, a wish list for the user (30A) may be created for upcoming events or celebrations such as birthdays, engagements, weddings and anniversaries, and in this regard, the user 30A can specify more than one item. The user may also create their own gift registry, which may be subsequently stored and selected by other users.

It is to be understood that in addition to products and/or services from gift item catalogue (120) provided in search results (i.e. search results based upon products and services of which details have previously been uploaded to a database by suppliers of the products and services), the search results may also accord with real-time searching for products and/or services using existing online search platforms such as Google Shopping™. It will be appreciated that in some instances there may be more than one supplier who may provide a particular product or service, and the platform itself may be configured to make a selection of a particular supplier (as described in greater detail below). Alternatively, the user (30A) creating the request may manually select the supplier (if required) at the time of selecting the gift item (60).

FIG. 5 illustrates gift contributors (30B), who may be contacts of the proposed gift recipient (30A), making contributions towards the gift item (60) selected by the gift recipient (30A). In particular, there is shown an application interface (270) that allows the user (30B) to view a gift item “wish list” of user (30A) and make a financial contribution (280) towards the purchase of the gift item (60). In the particular embodiment shown in FIGS. 4 and 5, the gift item is a bicycle (60A).

A skilled addressee will appreciate that the selection, by the user (30A), of a gift item (60A) takes the guess work out of the selection of a gift item by each of the gift contributors (30B). In addition, the users (30B) can select how much they prefer to contribute financially towards the selected gift item (60).

The identification of gift contributors (30B) associated with the user (30A) may be achieved automatically, e.g. by searching social media platforms associated with the user (30A) to identify those users who are linked or otherwise related to the user (30A). Alternatively, the user (30A) may be prompted to manually enter details relating to additional users (30B) whom the user (30A) prefers to make financial contributions towards the purchase of gift items (60) on their behalf.

There are various arrangements in which the gift contributors (30B) may be notified regarding a new request by a user (30A). For example, where the user (30A) has integrated one or more of their social media accounts, the gift contributors (30B) may be notified through their social media feeds that the user (30A) has an upcoming event or celebration and has created a gift item request on that basis. Alternatively, gift contributors (30B) may be notified directly by user (30A), e.g. verbally or by reference to the gift item request in a written invitation or by other similar means. If the gift contributors (30B) are not already registered to use the application (40) they may subsequently do so and any invitation to contribute towards a gift item (60) may also include instructions regarding how to access and install the application (40).

In the example of utilising social media to notify additional users (30B) regarding a gift item request, the user (30A) may select an option to create a social media campaign. In other words, causing details relating to a particular product or service nominated by the user (30A) to be published may include creating one or more social media campaigns that are viewable by the gift contributors (30B), thereby enabling the users (30B) to contribute funds to the purchase of the product or service. Each social media campaign associated with the user (30A) can be monitored and managed using the application (40) and/or the user's social media account(s). In this regard, the software application (40) is configured to integrate with social media platforms (90) to which the user (30A) is subscribed, as shown in FIG. 8.

In circumstances where there may be more than one supplier of a product, e.g. when a particular product or service does not form part of an existing product catalogue (120) but is located automatically using an online searching platform, the user (30A) may be prompted to select a supplier of the two or more suppliers listed. Further, the user (30A) may be prompted to specify whether the initially selected supplier is to remain selected throughout the entire campaign irrespective of the potential availability of a more favourable supplier, as described in greater detail below.

As mentioned previously, the application (40) may automatically select a supplier in circumstances where there is more than one supplier available for selection. For example, a particular supplier may be automatically selected based on one or more attributes of the particular supplier, including for example a category (e.g. a type of the nominated product or service), a price of the nominated product or service, a location of the particular supplier relative to the user (30A), whether the particular supplier is able to deliver the product or service directly to the user (30A), an estimated arrival time of the nominated product or service, and a quality rating associated with the particular supplier (70).

At the time of submitting a request to contribute funds towards a gift item (60), the users (30B) may nominate an amount of funds to be contributed, and each user (30B) may elect to contribute funds on a confidential basis, i.e. whether their particular contribution will be published or maintained confidential. Further, the maximum amount of funds that may be selected by a user (30B) during the course of a campaign may be based on one or more of a maximum donation limit specified by the proposed gift recipient (30A), and/or the remaining funds required to purchase the product or service according to the price of the product or service associated with a currently selected supplier.

Each request received from a device (50) associated with a gift contributor (30B) may include authorisation for a payment to be made towards the purchase of the product or service. In this way, the request authorises the indirect or direct transfer of funds from a bank account associated with a financial institution (80) of the gift contributor (30B) into an account associated with the supplier (70), or alternatively into an account associated with an independent trusted entity. For example, an administrator of application (40) may operate a virtual account into which funds may be deposited by users (30B) and the administrator may subsequently handle the transfer of same into the supplier bank account. The software application may be configured to enable each gift contributor (30B) to schedule instalment payments rather than requiring a single payment, and it is to be understood that the application (40) may provide the requisite functionality to enable such instalment payments to be implemented.

FIG. 6 depicts an example of a progress interface (290) which allows the users to view the progress of contributions made towards the item (60), as well as additional details relating to the gift item (60) including, for example, the selected supplier of the gift item (60). During this period of time where contributions are made toward the purchase of the gift item, a situation may arise in which a potentially more favourable supplier is identified. For example, after an initial selection of a particular supplier, the application (40) may be configured to conduct real-time monitoring of attributes of all available suppliers of a selected product or service to identify whether another supplier could be selected in place of the previously selected supplier based upon one or more attributes associated with the supplier. If the other supplier is identified as having more favourable attributes, then the supplier associated with the gift item to be purchased may be updated to reflect the supplier with more favourable attributes. For example, if a first supplier is selected based upon the price of the nominated product sold by the first supplier, and it is later determined (e.g. during the course of the campaign) that a second supplier offers the same nominated product or service at a reduced price, the second supplier may be automatically selected in place of the first supplier. This selection may be based upon one or more supplier attributes and is therefore not necessarily limited to which supplier is offering the product or service at the lowest price.

The users contributing financially toward the gift item (60) may also influence the particular supplier selected. For example, the users (30B) may be prompted to vote for one of the available suppliers based upon, for example, a past experience with a particular supplier, or a particular supplier being in some way associated with one of the gift contributors (e.g. a family member or friend), and such votes may further influence supplier selection. In some implementations, the gift contributors (30B) who are contributing more funds than others may be afforded additional influence with respect to the supplier selection (e.g. votes from such users (30B) may be afforded additional weight) as well as any additional decisions that are required to be resolved to procure a particular gift item (60).

During the period of time in which contributions are made toward the purchase of the gift item (60), each user (30) may receive an alert on their respective devices (50) when updates are available. Examples of updates may include, for example, new contributions made towards the purchase of a nominated product or service, sufficient contributions being made to fully fund the purchase of the product or service, selection of a new supplier (70), the product or service being delivered to the user (30A), and/or the product or service being received by the user (30A). In this regard, FIG. 6 provides an example interface (290) that may display an alert indicating that the gift item (60A) has been delivered (310) (e.g. by vehicle (320) from retailer (70)) and received by the gift recipient (30A). The retailer (70) may package the gift item to indicate that it was an item purchased utilising application (40), e.g. packaging of the item may include gift tags or wrapping signifying same, and one or more additional actions may automatically be effected as a result of the delivery of the item, e.g. the preparation and dispatch of acknowledgment cards to the various gift contributors (30B) who contributed to the purchase of the gift items (60).

In circumstances where an event date (or a final date upon which a particular item may be ordered prior to an event date, i.e. taking into account delivery time, etc) is approaching, and insufficient funds have been received toward the purchase of a selected gift item (60), one or more additional actions may be automatically performed. For example, the additional actions may include prompting each user (30B) who has contributed funds toward the item already to contribute additional funds to ensure the item (60) is purchased in time, transmitting requests or reminders to additional contacts of the user (30B) regarding the option to contribute toward the item before the due date, and notifying the user (30A) that insufficient funds were received and prompting the user (30A) to select an alternate item having a price accommodated by the total funds received from contributors (30B).

FIG. 7 illustrates some of the steps described above from the perspective of the supplier (70). In particular, FIG. 7 shows an example process associated with a particular retailer (70) uploading product information to a product catalogue (120), processing order payments (330) made by gift contributors (30B) via their financial institution (80), and subsequently shipping (310), via vehicle (320), the requested gift item (60A). It is to be understood that the payment functionality (140) may be configured to support payments via any known payment means, including for example, by credit card, Electronic Funds Transfer (EFT), Paypal or other payment platform. A small fee may also be payable towards the administrator of the software application by users (30) who utilise the application (40), e.g. by a subscription fee, as well as the suppliers (70) who upload products or services to product catalogues, e.g. a percentage of the sale price of particular products or services.

As mentioned previously, the user (30A) may nominate more than one product or service of interest and thereby create a “wish list”. According to one example, where the event is a wedding involving user (30A), the user (30A) may nominate a plurality of gift items (60) in their request. In this regard, the user (30A) may allocate a priority to the products or services nominated such that the products or services allocated a higher priority represent those which the first user (30A) prefers to be gifted as a priority over as compared with remaining items. In this way, it will be appreciated that the first user may effectively develop a gift registry without the involvement of third parties and which includes products and/or services selected and prioritised according to the user's own personal preferences.

As used herein, the term “server”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. 20. (canceled)

21. A computer-implemented method for collaborative gift purchasing, the method including:
receiving, by one or more processors, details relating to a first user including contact information relating to a plurality of additional users associated with the first user;
receiving, by one or more processors, from a data communications device associated with the first user, a nomination regarding a product or service that is available for purchase from one or more suppliers;
causing, by one or more processors, details relating to the product or service nominated by the first user to be published such that the details are viewable on data communication devices associated with the plurality of additional users;
monitoring, by one or more processors, receipt of requests from the data communication devices associated with the plurality of additional users to financially contribute funds to the purchase of said product or service for the first user, including when sufficient contributions have been made to fully fund the purchase of the product or service;
based on detecting that sufficient contributions have been made to fully fund the purchase of the product or service, causing, by one or more processors, the product or service to be purchased from a supplier of the one or more suppliers.

22. A method according to claim 21, wherein communications with the first and each additional user is facilitated by a dedicated software application operable on the data communication devices associated with each user, and the software application presents the first user with a search facility to search for and select one or more products or services.

23. A method according to claim 22, wherein the search facility is configured to allow the first user to filter search results according to any one or more of product, service, brand, supplier, product characteristic or event type, and wherein the search results are based upon a real-time search for products or services using one or more existing online platforms.

24. A method according to claim 21, wherein the method further includes automatically searching social medial platforms to which the first user is subscribed to identify those users who are linked or otherwise associated with the first user.

25. A method according to claim 21, wherein causing details relating to the product or service nominated by the first user to be published includes creating one or more social media campaigns viewable by the additional users thereby enabling the additional users to contribute funds to the purchase of the product or service.

26. A method according to claim 22, wherein each social media campaign associated with the first user is monitored and managed using the dedicated software application, wherein the dedicated software application is configured to integrate with social medial platforms to which the first user is subscribed.

27. A method according to claim 21, wherein the method further includes identifying, by one or more processors, the one or more suppliers from whom the nominated product or service may be purchased by automatically performing an online search of suppliers and/or searching a dedicated database of suppliers in respect of the nominated product or service.

28. A method according to claim 27, wherein when there is more than one supplier available for selection, the method further includes, automatically selecting, by one or more processors, a particular supplier based upon one or more attributes of the particular supplier, wherein the one or more attributes includes any one or more of:
a category of the nominated product or service,
a price of the nominated product or service,
a location of the particular supplier relative to the first user,
whether the particular supplier is able to deliver the product or service directly to the first user,
an estimated arrival time of the nominated product or service; and
a quality rating associated with the particular supplier.

29. A method according to claim 28, wherein after selection of a particular supplier has been made according to the one or more attributes of the particular supplier, the method further includes, conducting real-time monitoring, by one or more processors, of attributes of all available suppliers to identify whether another supplier should be selected in place of the previously selected supplier based upon the one or more attributes associated with the other supplier, and in the event the other supplier is identified as having more favourable attributes, selecting the other supplier in place of the previously selected supplier.

30. A method according to claim 21, wherein the additional users are provided with an opportunity to influence the selection of a particular supplier in the event more than one supplier is identified for selection.

31. A method according to claim 21, wherein the additional users are able to nominate, at the time of submitting a request to contribute funds, an amount of funds to be contributed, and each additional user that elects to contribute funds is prompted regarding whether their particular contribution will be published or retained confidential.

32. A method according to claim 31 wherein the maximum amount of funds that may be nominated by the plurality of additional users will be based upon one or more of:
a maximum donation limit specified by the first user, or
the remaining funds required to purchase the product or service according to the price of the product or service associated with the currently selected supplier.

33. A method according to claim 21, wherein each request received from the data communications device associated with the additional users includes authorisation from each additional user for payment toward the purchase of the product or service, and wherein the request authorises the indirect or direct transfer of funds from a bank account associated with the additional user into an account associated with an independent trusted entity.

34. A method according to claim 21, wherein each of the first user and the additional users receive an alert on their respective data communications device when one of more the following occurs:
a new contribution is made toward the purchase of the nominated product or service,
sufficient contributions have been made to fully fund the purchase of the nominated product or service,
a new supplier of the nominated product or service has been selected,
the nominated product or service has been delivered to the first user, and
the product or service has been received by the first user.

35. A method according to claim 21, wherein in the event the first user nominates more than one product or service of interest, the user also allocates a priority regarding each nominated product or service.

36. A system including:
one or more processors operable to:
receive details relating to a first user including contact information relating to a plurality of additional users associated with the first user;
receive, from a data communications device associated with the first user, a nomination in relation to a product or service that is available for purchase from one or more suppliers;
cause details relating to the product or service nominated by the first user to be published such that the details are viewable on data communications devices associated with the plurality of additional users;
monitor receipt of requests from the data communications devices associated with the plurality of additional users to financially contribute funds to the purchase of said product or service for the first user, including when sufficient contributions have been made to fully fund the purchase of the product or service;
based on detecting that sufficient contributions have been made to fully fund the purchase of the product or service, cause the product or service to be purchased from a supplier of the one or more suppliers.

37. A system according to claim 36, wherein the system is configured to provide the first user with a search facility to search for and select one or more products or services, wherein the search facility is configured to allow the first user to filter search results according to any one or more of product, service, brand, supplier, product characteristic or event type.

38. A system according to claim 36, further including a dedicated software application operable on the data communication device associated with each user, wherein the dedicated software application is configured to integrate with social medial platforms to which the first user is subscribed.

39. A system according to claim 36, wherein each of the first user and the additional users receive an alert on their respective data communications device when one of more the following occurs:
a new contribution is made toward the purchase of the nominated product or service,
sufficient contributions have been made to fully fund the purchase of the nominated product or service,
a new supplier of the nominated product or service has been selected,
the nominated product or service has been delivered to the first user, and
the product or service has been received by the first user.

40. A non-transitory computer-readable medium having a plurality of instructions executable by one or more processors to:
receive details relating to a first user including contact information relating to a plurality of additional users affiliated with the first user;
receive, from a data communications device associated with the first user, a nomination in relation to a product or service that is available for purchase from one or more suppliers;
cause details relating to the product or service nominated by the first user to be published such that the details are viewable on data communications devices associated with the plurality of additional users;
monitor receipt of requests from the data communication devices associated with the plurality of additional users to financially contribute funds to the purchase of said product or service on behalf of the first user, including when sufficient contributions have been made to fully fund the purchase of the product or service;
based on detecting that sufficient contributions have been made to fully fund the purchase of the product or service, cause the product to be purchased from a supplier of the one or more suppliers.
